(19) United States
(12) Patent Application Publication
(10) Pub. No.: US 2022/0178711 A1
(43) Pub. Date: Jun. 9, 2022

(54) METHODS AND SYSTEMS FOR DETECTING AN ENVIRONMENTAL ZONE IN A REGION

(71) Applicant: HERE Global B.V., Eindhoven (NL)

(72) Inventors: Advait Mohan RAUT, Virar West (IN); Leon STENNETH, Chicago, IL (US); Bruce BERNHARDT, Chicago, IL (US); Amarnath NAYAK, Mumbai (IN); Alex AVERBUCH, Buffalo Grove, IL (US)

(21) Appl. No.: 17/112,380

(22) Filed: Dec. 4, 2020

(51) Int. Cl. G01C 21/34; G01C 21/36

(52) U.S. Cl. CPC G01C 21/3461; G01C 21/3694; G01C 21/3415; G01C 21/3469

(57) ABSTRACT

System, method and computer program products are provided for detecting an environmental zone, generating a time schedule of an environmental zone in a region and providing route navigation instructions. The method may include obtaining at least one observation associated with the environmental zone in a region. The method may further include determining a confidence value associated with the at least one observation in the region and detecting the environmental zone in the region based on the confidence value associated with the at least one observation. The detection of the environmental zone comprises determining either one of a presence or an absence of the environmental zone in the region. Further, the detection of the environmental zone may be used to generate a time schedule indicating presence or absence of the environmental zone in the region for different time intervals.

### TECHNOLOGICAL FIELD

The present disclosure generally relates to routing and navigation applications, and more particularly relates to systems and methods for detecting an environmental zone in a region for routing and navigation applications.

### BACKGROUND

Various navigation applications are available to aid, for example, directions for driving, walking, or other modes of travel. Web-based and mobile app-based systems offer navigation applications that allow a user to request directions from one point to another. Often, a route traversed or to be traversed by a user encompasses several roads including environmental zones that are restricted for vehicles and other types of users.

Some environmental zones correspond to green zones that have restrictions on vehicle movement and/or operations. For example, vehicular movement into and out of the green zone is restricted, a vehicle (and thus a corresponding user) may have to pay a fee for entering the green zone, and the like. Thus, it would be helpful if the user is aware of the green zones and can be provided with reliable information in this regard.

### BRIEF SUMMARY

Green zones may be special type of environmental zones which are demarcated by pollution levels in a region in some situations. For example, when the pollution level in an area is more than a threshold value then all the vehicles may be restricted to enter that area for a specified time period. Similarly, sometimes the vehicle causing pollution level more than the threshold value may be restricted to enter the environmental zone. Sometimes, only the pedestrians, cyclists, and vehicles with green stickers may be allowed to enter the environmental zone to keep the pollution level in the green zone under control. For the purpose of explanation within the description in the following pages, the terms “green zone” and “environmental zone” may be used interchangeably to mean the same. However, the use of these terms in the manner suggested herein is not intended to limit the scope of this description and the term “environmental zone” in any way, as may be understood by a person of ordinary skill in the art. Therefore, there is a need for systems and methods that can determine the coverage of the environmental zone in a reliable, updated and efficient manner and also have an ability to generate a time schedule of the environmental zone, which may be used to provide navigational instructions to the vehicles based on the coverage and time schedule of the detected environmental zone.

Accordingly, in order to provide accurate and reliable navigation assistance, it is important to detect an environmental zone and generate a time schedule of an environmental zone in a region. To this end, the data utilized for providing navigation assistance should provide accuracy in generating time schedule of the environmental zone in the region. Especially, in the context of navigation assistance for autonomous vehicles and semi-autonomous vehicles, to avoid inaccurate navigation, it is important that the assistance provided is real-time and accurate. More importantly, in the context of autonomous vehicles, it is of utmost importance that the navigation assistance should generate a time schedule of the environmental zone and provide an alternative route to traverse to the autonomous vehicle well in time, in case navigation restrictions due to existence of environmental zone conditions are anticipated. Example embodiments of the present disclosure provide a system, a method, and a computer program product for detecting an environmental zone in a region and generating a time schedule of an environmental zone in the region.

Some example embodiments disclosed herein provide a method for detecting an environmental zone, the method comprising obtaining at least one observation associated with the environmental zone in a region. The method may further include determining a confidence value associated with the at least one observation in the region and detecting the environmental zone in the region based on the confidence value associated with the at least one observation in the region, wherein detecting comprises determining either one of a presence or an absence of the environmental zone in the region.

According to some example embodiments, detecting the environmental zone further comprises detecting a coverage area associated with the environmental zone in the region.

According to some example embodiments, the method further comprises generating a time schedule for the environmental zone based on the determined coverage area of the environmental zone in the region.

According to some example embodiments, the method further comprises predicting either one of the presence or absence of the environmental zone based on the generated time schedule and the coverage area of the environmental zone.

According to some example embodiments, obtaining the at least one observation associated with the environmental zone in the region further comprises obtaining the at least one observation based on at least one of road sign data, one or more pollution sensors, and one or more other sensors in a vehicle.

According to some example embodiments, the at least one observation further comprises at least one of a positive observation and a negative observation. The positive observation is associated with a first determination of presence of environmental zone in the region. The negative observation is associated with a second determination of absence of environmental zone in the region.

According to some example embodiments, each of the at least one positive observation and the at least one negative observation is associated with a time interval associated with each day in a week.

According to some example embodiments, determining the confidence value associated with the at least one observation further comprises determining a plurality of observations in the region for the time interval associated with the at least one observation, wherein the plurality of observations include a plurality of positive observations and a plurality of negative observations. The plurality of positive observations may be aggregated to determine an aggregated positive observation value. The plurality of negative observations may be aggregated to determine an aggregated negative observation value. The confidence value may then be determined based on the aggregated positive observation value and the aggregated negative observation value.

According to some example embodiments, determining the confidence value further comprises monitoring, in real time, a change in confidence value associated with the at least one observation in the region.

According to some example embodiments, the method further comprises determining confidence value of at least one missing observation for the region based on a historical confidence value associated with the at least one observation.

According to some example embodiments, the method further comprises generating navigational alerts associated with the detection of the environmental zone in the region.

According to some example embodiments, the method further comprises generating alternate routes for navigation based on the detection of the environmental zone.

According to some example embodiments, the method further comprises updating a coverage of the environmental zone in a map database, wherein the coverage is indicated by a polygon shape in the map database.

According to some example embodiments, the region comprises at least one of a location point, a map tile area, a road segment, and a lane.

Some example embodiments disclosed herein provide a system for generating a time schedule of an environmental zone in a region, the system comprising a memory configured to store computer-executable instructions and one or more processors configured to execute the instructions to obtain, for a predefined time interval, at least one observation associated with the environmental zone in the region. The one or more processors are further configured to execute the instructions to determine, for the predefined time interval, a confidence value associated with the at least one observation and generate a time schedule for the environmental zone in the region based on the determined confidence value and the predefined time interval.

Some example embodiments disclosed herein provide a computer programmable product comprising a non-transitory computer readable medium having stored thereon computer executable instructions which when executed by one or more processors, cause the one or more processors to carry out operations for providing navigation instructions, the operations comprising obtaining route information for navigation of at least one vehicle in a region. The operations further comprise determining, based on map data and the route information, at least one location associated with a confidence value related to an environmental zone in the region. The operations further comprise determining a coverage area for the environmental zone in the region based on the determined at least one location and providing the navigation instructions for operation of the at least one vehicle in the region based on the determined coverage area for the environmental zone in the region.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a schematic diagram of a network environment of a system for detecting an environmental zone and generating a time schedule of an environmental zone in a region, in accordance with an example embodiment;

FIG. 2 illustrates a block diagram of a system for detecting an environmental zone and generating a time schedule of an environmental zone in a region, in accordance with an example embodiment;

FIG. 3A illustrates an exemplary scenario for detecting an environmental zone and generating a time schedule of an environmental zone in a region, in accordance with an example embodiment;

FIG. 3B illustrates an exemplary scenario for obtaining observations related to an environmental zone in a region, in accordance with an example embodiment;

FIGS. 4A-4B illustrate exemplary tables for obtaining observations related to an environmental zone in a region, in accordance with one or more example embodiments;

FIG. 4C illustrates an exemplary method for updating the tables shown in FIGS. 4A-4B, in accordance with an example embodiment;

FIG. 4D illustrates an exemplary scenario for confidence value determination, in accordance with an example embodiment;

FIGS. 5A-5B illustrate an exemplary representation of map data for displaying an environmental zone in a region, in accordance with one or more example embodiments; and

FIGS. 6A-6C illustrate flow diagrams of methods for detecting an environmental zone and generating a time schedule of an environmental zone in a region, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “link” may be used to refer to any connecting pathway including but not limited to a roadway, a highway, a freeway, an expressway, a lane, a street path, a road, an alley, a controlled access roadway, a free access roadway and the like.

The term “route” may be used to refer to a path from a source location to a destination location on any link.

The term “environmental zone” may refer to a routing zone such as an area or a road or a link or a pathway on which restrictions may be imposed on movement and/or operations of vehicles based on factors such as emission levels of vehicles, environmental pollution levels, type of vehicle and vehicle characteristics and the like. The environmental zone may interchangeably be referred to as a “green zone”. For example, a green zone may be a special type of environmental zone with environmental zone restrictions applied, such as only vehicles that meet certain emission standards are permitted to be driven in the green zone, only vehicles which are identified as such by a special color-coded sticker may be allowed to enter in the green zone and the like. Vehicles that do not meet these standards may not be permitted inside the environmental zone.

The term “autonomous vehicle” may refer to any vehicle having autonomous driving capabilities at least in some conditions. An autonomous vehicle, as used throughout this disclosure, may refer to a vehicle having autonomous driving capabilities at least in some conditions. The autonomous vehicle may also be known as a driverless car, robot car, self-driving car or autonomous car. For example, the vehicle may have zero passengers or passengers that do not manually drive the vehicle, but the vehicle drives and maneuvers automatically. There can also be semi-autonomous vehicles.

### End of Definitions

Embodiments of the present disclosure may provide a system, a method and a computer program product for detecting an environmental zone and generating a time schedule of an environmental zone in a region for routing.

Some embodiments provide a system and a method for detecting a presence or an absence of the environmental zone in the region. Further, based on the detection, navigation instructions for controlling the operation of a vehicle may be provided. For example, a navigation instruction may include providing a routing instruction to the vehicle (and the user) by providing an alternate route for navigation of the vehicle. The alternate route may be a route which does not include the environmental zone. In some embodiments, the alternate route may be updated in real-time based on dynamic detection of the environmental zone. The dynamic detection of the environmental zone comprises updating a coverage area of the environmental zone dynamically, such as in real time, based on a change in environmental conditions associated with the detection of the environmental zone. The change in environmental conditions may be determined based on a confidence value associated with the environmental zone. The confidence value may be a numerical value between 0 and 1 that indicates the likelihood of presence of the environmental zone in the region, with 0 meaning no environmental zone, 1 meaning environmental zone active and 0.5 meaning 50% likely that environmental zone is active (or present)

In some embodiments, controlling the operation of a vehicle may include adjusting an emission level for the vehicle based on the detection of the environmental zone restriction in the region. For example, the vehicle may be equipped with an emission control system that may be able to control emission of pollution causing gases from the vehicle on being triggered. The trigger may be provided on detection of the environmental zone condition in the region and an indication that vehicle operation needs to be controlled, such as by the navigation instruction.

Some embodiments provide a system and a method for providing a time schedule for the environmental zone in the region. The time schedule comprises such as data indicating either one of the presence or absence of the environmental zone in the region for a sub-interval in a plurality of time intervals. The plurality of time intervals may each be of equal length, such as 1 hour, 30 min, 15 min etc., which may be configurable. Further the plurality of intervals may be used to divide each day of the week into plurality of sub-intervals based on the length of each of the plurality of time intervals. For example, if the length of each time interval for the plurality of time intervals is chosen as 1 hour, then each day is divided into 24 sub-intervals. Further, for each sub-interval detection of the presence or absence of the environmental zone is done for the region.

Thus, based on the systems and methods discussed herein, environmental zone conditions may be dynamically detected, and a precise time schedule for existence or non-existence of the environmental zone may also be provided to the user. The user can get up to date information about the environmental zone conditions in a region, which are dynamically updated in real time, and thus, provide efficient and accurate environmental zone information. Further, since the time schedule is efficiently generated, a user can be informed about existence of such conditions on their planned navigation route well in time and can even be provided navigation instructions for efficient routing and vehicle operation. Also, since the information is timely and precise, the user can be saved from having to pay heavy fee in case they are about to enter a region with active environmental zone conditions and their vehicle is either high on emissions or does not have a sticker which permits the vehicle to enter into the environmental zone, such as a green zone. Also, the detection of environmental zone, generation of time schedule and dynamic update of the environmental zone related information may be done by a map layer of a mapping service provider, thereby making the systems and methods disclosed herein computationally efficient for the user and requiring very less computational resources at the user end. The end user, such as a consumer of an autonomous or semi-autonomous vehicle or an automobile maker of such vehicles may subscribe to the systems and methods provided herein as a service provided by the mapping service provider. These and other technical improvements of the systems and methods disclosed herein may become apparent with the following description of various embodiments described herein.

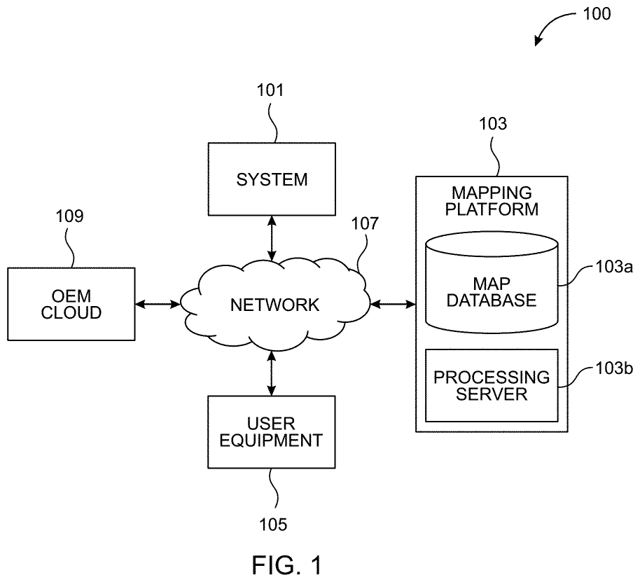

The system, the method, and the computer program product facilitating detection of an environmental zone and generating a time schedule of an environmental zone in a region are described with reference to FIG. 1 to FIG. 6A-6C.

FIG. 1 illustrates a schematic diagram of a network environment 100 of a system 101 for detecting an environmental zone and generating a time schedule of an environmental zone in a region, in accordance with an example embodiment.

The system 101 may be communicatively coupled to a mapping platform 103, a user equipment 105 and an OEM (Original Equipment Manufacturer) cloud 109 connected via a network 107. The mapping platform further comprising a map database 103a and a processing server 103b. The components described in the network environment 100 may be further broken down into more than one component such as one or more sensors or application in user equipment and/or combined in any suitable arrangement. Further, it is possible that one or more components may be rearranged, changed, added, and/or removed.

In an example embodiment, the system 101 may be embodied in one or more of several ways as per the required implementation. For example, the system 101 may be embodied as a cloud based service or a cloud based platform. As such, the system 101 may be configured to operate outside the user equipment 105. However, in some example embodiments, the system 101 may be embodied within the user equipment 105, for example as a part of an in-vehicle navigation system. In each of such embodiments, the system 101 may be communicatively coupled to the components shown in FIG. 1 to carry out the desired operations and wherever required modifications may be possible within the scope of the present disclosure. In various embodiments, the system 101 may be a backend server, a remotely located server, a cloud server or the like. In an embodiment, the system 101 may be the processing server 103b of the mapping platform 103 and therefore may be co-located with or within the mapping platform 103. The system 101 may be implemented in a vehicle, where the vehicle may be an autonomous vehicle, a semi-autonomous vehicle, or a manually driven vehicle. Further, in one embodiment, the system 101 may be a standalone unit configured for detecting an environmental zone and generating a time schedule of an environmental zone in a region. Alternatively, the system 101 may be coupled with an external device such as the autonomous vehicle.

The mapping platform 103 may comprise the map database 103a for storing map data and the processing server 103b for carrying out processing instructions. The map database 103a may store node data, road segment data, link data, point of interest (POI) data, link identification information, heading value records, environmental zone data, time schedule data for the environmental zone or the like. In some embodiments, the map database 103a comprises a map layer specially configured for storing environmental zone data. The environmental zone data in the map layer further comprises time schedule data for the environmental zone. The time schedule data may comprise information about times of day when environmental zone restrictions are active at various regions defined in the map database 103a. These regions may be defined by geographic coordinate data for a location, map tile data, road segment data, link level data, lane level data and the like. In some embodiments, the regions may be demarcated by polygons representing coverage area for the environmental zone within the region, such as within a map tile.

In some embodiments, the map database 103a further includes speed limit data of each lane, cartographic data, routing data, and/or maneuvering data. Additionally, the map database 103a may store information associated with environmental zones in a region. The environmental zones are established with the aim of improving air quality and the health of the residents living in the environmental zone. In an embodiment, each environmental zone is assigned an environmental zone id, which may be stored in the map layer of the map database 103a. And for each environmental zone different environmental zone conditions and polygons may be stored in the map database 103a which may be updated based on the changes in the environmental zone in real time or in time epochs, which are predefined time intervals. Additionally, the map database 103a may be updated dynamically to cumulate real time traffic conditions. The real time traffic conditions may be collected by analyzing the location transmitted to the mapping platform 103 by many road users through the respective user devices of the road users. In one example, by calculating the speed of the road users along a length of road, the mapping platform 103 may generate a live traffic map, which is stored in the map database 103a in the form of real time traffic conditions. In one embodiment, the map database 103a may further store historical traffic data that includes travel times, average speeds and probe counts on each road or area at any given time of the day and any day of the year. In an embodiment, the map database 103a may store the probe data over a period for a vehicle to be at a link or road at a specific time. The probe data may be collected by one or more devices in the vehicle such as one or more sensors or image capturing devices or mobile devices. In an embodiment, the probe data may also be captured from connected-car sensors, smartphones, personal navigation devices, fixed road sensors, smart-enabled commercial vehicles, and expert monitors observing accidents and construction. In some embodiments, the probe data includes data related to environmental zones. For e.g. probe vehicles equipped with one or more sensors may be configured to collect information about posted green zone signs on various roads. Probe vehicles may also be equipped with special pollution sensors to detect real time pollution levels and if the pollution level is greater than a threshold pollution level, report the environmental zone condition of yes. Further, if the pollution level is less than the threshold pollution level, report the environmental zone condition of no.

In some embodiments, data related to environmental zone, as stored in map database 103a is collected by consumer vehicles or end user vehicles. However, this data from consumer vehicles may first be sent to the OEM cloud 109 for anonymization, and then the anonymized vehicle data is sent to the map database 103a.

In some embodiments, data related to environmental zone, as collected by consumer vehicles, is directly sent to the map database 103a and anonymization is done in the map database 103a itself.

According to some example embodiments, the map database 103a may store data related to segment data records such as node data, links or segments representing roads, streets, or paths, as may be used in calculating a route or recorded route information for determination of one or more personalized routes. The node data may be end points (e.g., representing intersections) corresponding to the respective links or segments of road segment data. The road link data and the node data may represent a road network used by vehicles such as cars, trucks, buses, motorcycles, and/or other entities.

Optionally, the map database 103a may contain path segment and node data records, such as shape points or other data that may represent pedestrian paths, links or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 103a may also store data about the POIs and their respective locations in the POI records.

The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data.

The map database 103a may be maintained by a content provider e.g., a map developer. By way of example, the map developer may collect geographic data to generate and enhance the map database 103a. There may be different ways used by the map developer to collect data. These ways may include obtaining data from other sources, such as municipalities or respective geographic authorities. In addition, the map developer may employ field personnel to travel by vehicle along roads throughout the geographic region to observe features and/or record information about them, for example. Also, remote sensing, such as aerial or satellite photography, may be used to generate map geometries directly or through machine learning as described herein.

In some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the user equipment 105. The navigation-related functions may correspond to vehicle navigation, pedestrian navigation or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in or with end user equipment such as the user equipment 105 to provide navigation and/or map-related functions. For example, the map database 103a may be used with the user equipment 105 to provide an end user with navigation features. In such a case, the map database 103a may be downloaded or stored locally (cached) on the user equipment 105.

The processing server 103b may comprise processing means, and communication means. For example, the processing means may comprise one or more processors configured to process requests received from the user equipment 105. The processing means may fetch map data from the map database 103a and transmit the same to the user equipment 105 via OEM cloud 109 in a format suitable for use by the user equipment 105. In another embodiment, the data collected from the vehicles is transmitted to the OEM cloud 109 for anonymization and then back to mapping platform 103 for further processing and aggregation. In one or more example embodiments, the mapping platform 103 may periodically communicate with the user equipment 105 via the processing server 103b to update a local cache of the map data stored on the user equipment 105. Accordingly, in some example embodiments, the map data may also be stored on the user equipment 105 and may be updated based on periodic communication with the mapping platform 103.

In some example embodiments, the user equipment 105 may be any user accessible device such as a mobile phone, a smartphone, a portable computer, and the like that are portable in themselves or as a part of another portable/mobile object such as a vehicle. The user equipment 105 may comprise a processor, a memory and a communication interface. The processor, the memory and the communication interface may be communicatively coupled to each other. In some example embodiments, the user equipment 105 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the user equipment 105 may comprise processing means such as a central processing unit (CPU), storage means such as onboard read only memory (ROM) and random access memory (RAM), acoustic sensors such as a microphone array, position sensors such as a GPS sensor, gyroscope, a LIDAR sensor, a proximity sensor, motion sensors such as accelerometer, a pollution sensor, a camera or other image sensors, a display enabled user interface such as a touch screen display, and other components as may be required for specific functionalities of the user equipment 105. Additional, different, or fewer components may be provided. For example, the user equipment 105 may be configured to execute and run mobile applications such as a messaging application, a browser application, a navigation application, and the like. In one embodiment, at least one user equipment such as the user equipment 105 may be directly coupled to the system 101 via the network 107. For example, the user equipment 105 may be a dedicated vehicle (or a part thereof) for gathering data for development of the map data in the database 103a. In some example embodiments, at least one user equipment such as the user equipment 105 may be coupled to the system 101 via the OEM cloud 109 and the network 107. For example, the user equipment 105 may be a consumer vehicle (or a part thereof) and may be a beneficiary of the services provided by the system 101. In some example embodiments, the user equipment 105 may serve the dual purpose of a data gatherer and a beneficiary device. The user equipment 105 may be configured to capture sensor data associated with a road which the user equipment 105 may be traversing. The sensor data may for example include pollution level information in an area collected by pollution sensors in the vehicles. In another embodiment, the sensor data may be image data of road objects, road signs, or the surroundings (for example buildings). The sensor data may refer to sensor data collected from a sensor unit in the user equipment 105. In accordance with an embodiment, the sensor data may refer to the data captured by the vehicle using sensors.

The network 107 may be wired, wireless, or any combination of wired and wireless communication networks, such as cellular, Wi-Fi, internet, local area networks, or the like. In one embodiment, the network 107 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G or 6G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an embodiment the network 107 is coupled directly or indirectly to the user equipment 105 via OEM cloud 109. In an example embodiment, the system may be integrated in the user equipment 105. In an example, the mapping platform 103 may be integrated into a single platform to provide a suite of mapping and navigation related applications for OEM devices, such as the user devices and the system 101. The system 101 may be configured to communicate with the mapping platform 103 over the network 107. Thus, the mapping platform 103 may enable provision of cloud-based services for the system 101, such as, anonymization of observations in the OEM cloud 109 in batches or in real-time.

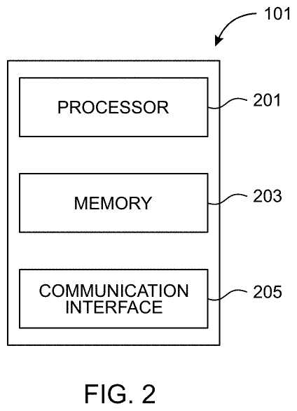

FIG. 2 illustrates a block diagram of a system 101 for detecting an environmental zone and generating a time schedule of an environmental zone in a region, in accordance with an example embodiment. The system 101 may include a processing means such as at least one processor 201 (hereinafter, also referred to as “processor 201”), storage means such as at least one memory 203 (hereinafter, also referred to as “memory 203”), and a communication means such as at least one communication interface 205 (hereinafter, also referred to as “communication interface 205”). The processor 201 may retrieve computer program code instructions that may be stored in the memory 203 for execution of the computer program code instructions.

The processor 201 may be embodied in several different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101, where the users may be a traveler, a rider, a pedestrian, and the like. In some embodiments, the users may be or correspond to an autonomous or a semi-autonomous vehicle. The IoT related capabilities may in turn be used to provide smart navigation solutions by providing real time updates to the users to take pro-active decision on turn-maneuvers, lane changes, overtaking, merging and the like, big data analysis, and sensor-based data collection by using the cloud based mapping system for providing navigation recommendation services to the users. The system 101 may be accessed using the communication interface 205. The communication interface 205 may provide an interface for accessing various features and data stored in the system 101.

Additionally, or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communications to and from the user equipment 105 or any other component with which the system 101 may communicate. The communication interface 205 may be any means such as a device or circuitry embodied in either hardware or a combination of hardware and software that is configured to receive and/or transmit data to/from a communications device in communication with the user equipment 105. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to handle receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms.

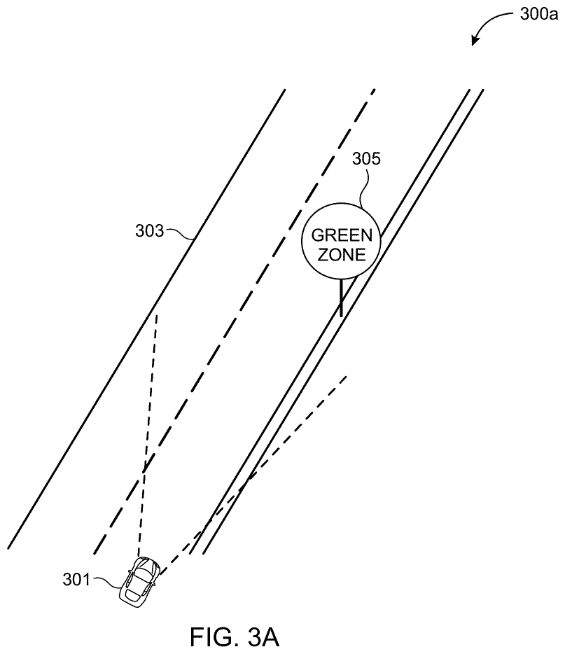

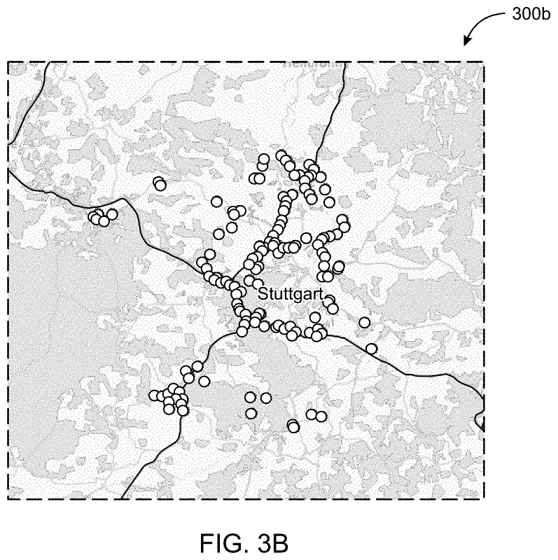

FIG. 3A illustrates an exemplary scenario 300a for detecting an environmental zone in a region and generating a time schedule of an environmental zone in the region, in accordance with an example embodiment. According to one example embodiment, a vehicle 301 (such as the vehicle/user equipment 105) may be traveling on a road 303. The road 303 may be part of a way leading the vehicle 301 from a source location to a destination location. In one example, the road 303 may be a road that may be a part of an environmental zone or green zone. To that end, the road 303 may be an entry path signaling the beginning of the environmental zone or an exit path signaling the end of the environmental zone. The information about the start or end of the environmental zone, such as the green zone may be shown by road sign 305, such as by displaying the label “green zone” on the road sign 305. The road sign 305 shown in FIG. 3A is a banner that may indicate start of the green zone and a similar road sign may be placed at a place on the road 303 to indicate the end of the green zone, as defined previously.

In an example embodiment, the vehicle 301 may request for a route between two locations and the road 303 may be a part of the requested route. Further, the road sign 305 may indicate that the environmental zone starts from this point. In an embodiment, the vehicle 301 may detect the region as environmental zone by observing the road sign 305 using the vehicle's onboard sensors. For example, the vehicle 301 may detect the region as environmental zone by observing the road sign 305 using a camera, a LIDAR sensor, a depth sensor, a GPS sensor and the like. In another embodiment, the vehicle 301 may detect that the region is an environmental zone based on the sensor data collected from one or more other sensors in the vehicle 301. For example, pollution sensors may detect that the pollution level in the region including the road 303 is above a threshold value and hence the region is to be considered as environmental zone. The system 101 may be invoked upon receipt of the request for a route for navigation. The system 101 may also be invoked for providing navigational alert to the vehicle 301 automatically, on detection of the environmental zone in the region including the road 303. Based on the request from vehicle 301, the system 101 may be configured to determine coverage and time schedule of the environmental zone. Alternately, the environmental zone may already be indicated in the route for the vehicle 301 and the system 101 may be invoked to generate alternate route for the vehicle 301 on the basis of the detected environmental zone and the coverage area of the environmental zone. Irrespective of the way the system 101 is invoked, the system 101 may provide measures for detecting an environmental zone and generating a time schedule of an environmental zone in a region.

On being invoked, the system 101 may obtain at least one observation associated with the environmental zone in the region, such as on the road 303. In an embodiment, at least one observation may be reported by plurality of vehicles in the environmental zone. For example, one vehicle may obtain the environmental zone observation at one location in the region and another vehicle may report the environmental zone observation at other location in the region. Further, the at least one observation may be reported at a first time epoch, say between 1 AM-2 AM, at a first location by a first vehicle. Further, a second observation is reported by the same first vehicle at a second location in a second time epoch, say between 2 AM-3 AM. Like this, a plurality of observations associated with the environmental zone conditions may be obtained. Further, the time epoch may correspond to a time interval of any length or duration, such as 1 hour, 30 minutes, 15 minutes, 5 minutes and the like, based on the frequency of update required for environmental zone information.

FIG. 3B illustrates an exemplary map tile 300b showing obtained plurality of observations for environmental zone at plurality of locations using a vehicle sensor data. The dots in the map tile 300b show the locations for which environmental zone observations were obtained within a region defined by the map tile. For example, the map tile 300b corresponds to the region Stuttgart in Germany, and the dots represent locations where a green zone road sign was observed by a vehicle using their onboard sensors, such as a camera. The plurality of observations in FIG. 3B were collected for a period of 24 hours for the region shown in map tile 300b.

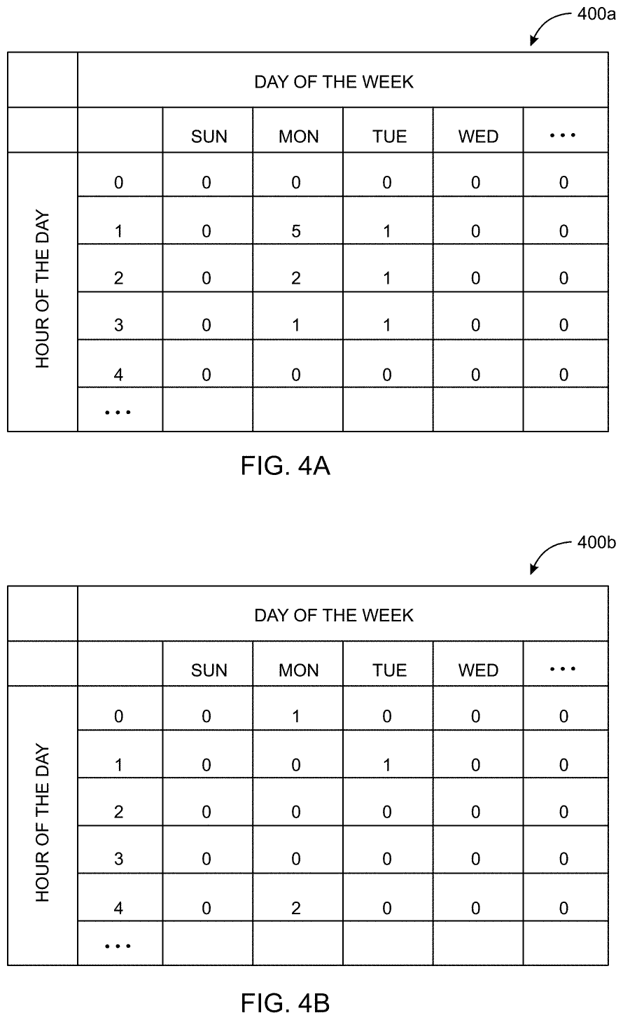

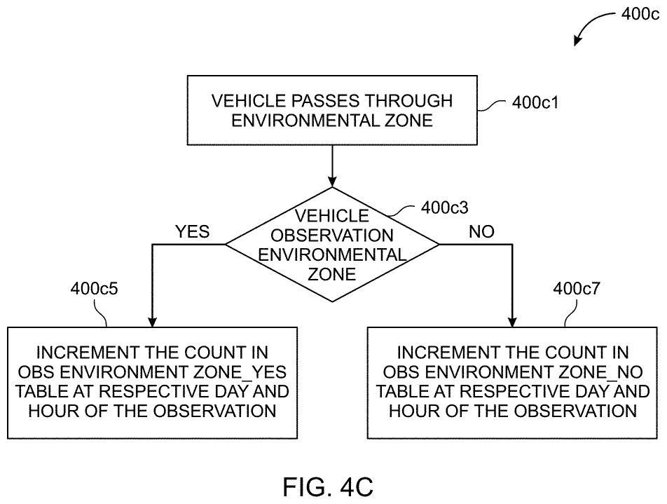

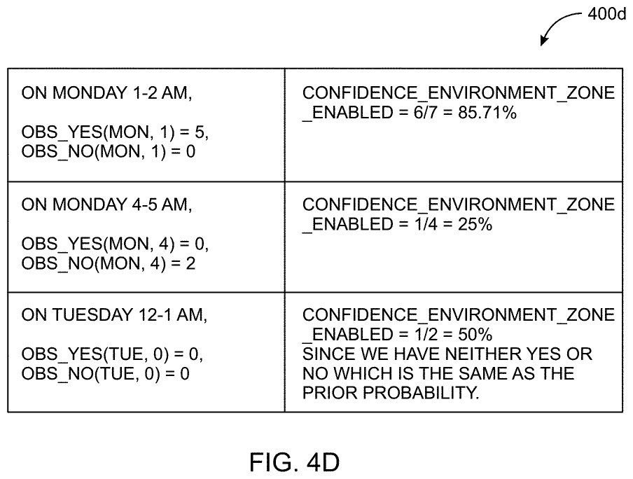

In an embodiment, the region may correspond to a single map tile, such as the map tile 300b, or multiple map tiles, a geographic area, a POI, a street, a lane and the like. In an embodiment, the at least one observation may include at least one of a positive observation and a negative observation, a detailed description of which is provided next with reference to FIGS. 4A-4C. The positive observation is associated with a first determination of presence of environmental zone in the region and the negative observation is associated with a second determination of absence of environmental zone in the region. Further, each of the at least one positive observation and the at least one negative observation may be associated with a time interval, for example an epoch of predefined length discussed earlier, associated with each day in a week. The system 101 may further determine the confidence value associated with the at least one observation in the region. The confidence value is a numerical value between 0 and 1, which represents a degree of confidence and likelihood attributed to the correctness and accuracy of the observation to which it is attributed. For example, a confidence value of 0.1 means 10% confidence and likeliness of the observation being correct and accurate, while a confidence value of 0.9 would mean 90% confidence and likeliness of the observation being correct.

In some embodiments, the system 101 may continuously monitor the change in confidence value to determine the coverage of the environmental zone and thus, environmental zone data may be updated dynamically in near real-times. Based on the change in confidence value, the system 101 may determine the presence or absence of environmental zone in the region and accordingly update the coverage area and its extents/limits to depict up to date coverage area for the environmental zone. Also, based on the time interval information available for the coverage area of the environmental zone in the region, a time schedule for the environmental zone may also be generated.

For example, the system 101 may obtain ten observations in a region. And while continuously monitoring the change in confidence value, the system 101 may determine that the confidence value of three observations is low and the area associated with those three observations is no longer under environmental zone. The system 101 may further update about the coverage of the environmental zone in the map database, a detailed description of which is provided next with reference to FIGS. 4A-4D.

In an embodiment, the system 101 may generate the time schedule of the environmental zone in the region. The system 101 may further obtain, for a predefined time interval, a plurality of observations associated with the environmental zone in the region. In an embodiment, the predefined time interval may be the time epoch as discussed previously. The system 101 may further determine the at least one positive observation and at least one negative observation associated with the environmental zone in the region for the predefined time interval. Like this, the system 101 may obtain a plurality of observations for the environmental zone in the region during the time interval defined by the time epoch. These plurality of observations may be observed by a plurality of vehicles during the defined time interval, for the region under considerations. The plurality observations may include both the types of observations: plurality of positive observations, when some plurality of vehicles report environmental zone condition as present or “YES”; and plurality of negative observations, when some plurality of vehicles report environmental zone condition as absent or “NO”. The system 101 may further aggregate the plurality of positive observations to determine an aggregated positive observation value and aggregate the plurality of negative observations to determine the aggregated negative observation value. Further, the system 101 determines the confidence value based on the aggregated positive observation value and the aggregated negative observation value. Based on the confidence value, the system 101 may detect either one of a presence or an absence of the environmental zone based on the confidence value and generates the time schedule of the environmental zone based on the detection. The calculation of confidence value in this manner is further explained in detail in FIG. 4A-4D. FIGS. 4A-4B illustrate exemplary tables for obtaining observations related to an environmental zone in a region.

FIG. 4A illustrates an exemplary table 400a of positive observations associated with the environmental zone, for a predefined time interval, such as a week, for a location. In an embodiment, the at least one positive observation is the observation when the pollution level in the region is greater than a threshold value or when a vehicle has observed a posted green zone road sign. In FIG. 4A, there are plurality of positive observations for environmental zone, which are captured for a predefined time interval by plurality of vehicles.

Table 400a includes top row containing days of a week in different columns, and first column containing hours of a day. Hour 0 represents 0th hour, which is 12 AM-1 AM, which forms row 1 of the table 400a. For example, in the third column of table 400a, row 2 shows the number ‘5’, which means five positive observations were obtained on Mon for sub-interval 1 AM to 2 AM by vehicles for a particular region, which may further be specified to be a location. This may also be represented as OBS_YES(Mon,2)=5, where OBS_YES means observations with environmental zone detection output as “YES”, that is environmental zone is present. Similarly, in the fifth column of table 400a, the plurality of positive observations obtained by vehicles on Wednesday for sub-interval 3 AM-4 AM is zero, which means OBS_YES(Wed, 4)=0, that is to say, no environmental zone was observed by any vehicle that crossed the region between 3 AM and 4 AM on Wednesday. Further, the system 101 may send these observations for anonymization to OEM cloud 109. The OEM cloud 109 may perform anonymization algorithms for the plurality of positive observations and then send the observations to the map database 103a. Alternately, the map database 103a may itself anonymize the plurality of positive observations before using them for further processing.

FIG. 4B illustrates an exemplary table 400b of negative observations associated with the environmental zone, for a predefined time interval, such as a week, for a location. In an embodiment, the at least one negative observation is the observation when the pollution level in the region is lesser than a threshold value or when a vehicle has not observed any posted green zone road sign. In this case, vehicular emissions are under permissible limits, and need to be considered while monitoring entry or exit of vehicles in any regions. In FIG. 4B, there are plurality of negative observations for environmental zone, which are captured for a predefined time interval by plurality of vehicles.

In Table 400b, the structure and organization of data is like table 400a. Thus, table 400b represents, for example, two negative observations on Monday from 4 AM to 5 AM. This may be represented as OBS_NO(Mon,5)=2, where OBS_NO means observations with environmental zone detection output as “NO”, that is environmental zone is not present. The OEM cloud 109 may perform anonymization algorithms for the plurality of negative observations in table 400b and then send these plurality of negative observations to the map database 103a. Alternately, the map database 103a may itself anonymize the plurality of negative observations before using them for further processing

In some embodiments, the plurality of positive observations in table 400a and the plurality of negative observations in table 400b may be used to continuously update the map database 103a. For example, in the map database 103a there may be the map layer storing the environmental zone related data. This data may include the tables 400a and 400b. Further, whenever more vehicles report at least one positive observation or negative observation, the tables 400a and 400b may be updated in real time.

FIG. 4C illustrates a method 400c for updating the tables 400a and 400b shown in FIGS. 4A and 4B.

The method 400c begins at step 400c1 when a vehicle passes through an environmental zone in a region. At step 400c3, the vehicle obtains at least one observation for the environmental zone in the region. This observation may be obtained using vehicle's onboard sensors. The onboard sensors may either report a posted green zone sign or may report a pollution level estimation in the region. Based on the observation reported by the vehicle at 400c3, two possibilities may arise. If the environmental zone condition is detected, then at 400c5, the corresponding count in the table 400a for positive observations, also referred to as Obs Environmental Zone_YES is incremented. However, if environmental zone condition is not detected, then at 400c7, the corresponding count in the table 400a for negative observations, also referred to as Obs Environmental Zone_NO is incremented.

The cell to be updated in table 400a or 400b is identified based on two criteria: 1) identified region/location, and 2) time of day (and thus corresponding sub-interval for identifying the hour of the day).

Thus, using the method 400c, the map database 103a may be updated in real time with environmental zone data. Further, the method 400c enables dynamic update of the environmental zone data in the map database 103a, thereby making the system 101 highly accurate, reliable, up to date and efficient. Not only this, the continuous monitoring of environmental zone information in this manner makes the system 101 highly dynamic and robust. This updated information about the environmental zone may be used to calculate an updated confidence value for the environmental zone, which may be further used to provide updated navigational instructions to the vehicle 301 traversing through the region, such as the road 303.

FIG. 4D illustrates an exemplary scenario in a table 400d showing calculation of the confidence value at different days and time epochs for a location. After obtaining the plurality of positive observation and the plurality of negative observations, the system 101 may further aggregate the plurality of positive observation and the plurality of negative observation to compute the confidence value. The aggregation of the plurality of positive observations and plurality of negative observations to determine the confidence value is shown as

$$\frac{OBS\_YES ( day , hour ) + 1}{OBS\_YES ( day , hour ) + OBS\_NO ( day , hour ) + 2} \qquad ( 1 )$$

where, OBS_YES denotes the yes observation or positive observation on a particular day and in a time epoch (or sub-interval) and OBS_No denotes the no observation or negative observation at same location and in the same time epoch. The equation (1) calculated for determining confidence value may be based on one or more different frameworks. For example, an algorithm associated with Bayesian Framework may be used to compute confidence value. In an embodiment, the confidence value on Monday for the sub-interval from 1 AM to 2 AM is calculated based on the equation (1) and using the plurality of positive observations in table 400a and the plurality of negative observations in table 400b. The number of aggregated plurality of positive observations from table 400a in this time epoch is five. Similarly, the number of aggregated plurality of negative observations from table 400b for this time epoch is zero. Therefore, using these observations in equation (1), the confidence value of the environmental zone is 85.71%. Similarly, the confidence value on Monday from 4 AM to 5 AM is calculated based on the equation (1) and using the plurality of positive observations in table 400a and the plurality of negative observations in table 400b. The number of aggregated plurality of positive observations from table 400a in this time epoch is zero. Similarly, the number of negative observations from table 400b in this time epoch is two. Therefore, using these values in equation (1), the confidence value of the environmental zone is 25%. In an embodiment, in case when the value of positive observation and negative observation is zero, the system 101 may be configured to take prior probability for both observation-yes and observation-no to be 0.5 and 0.5. In an embodiment, if the one or more observations are missing for a particular time epoch, then the system 101 may determine the confidence values of missing observation based on the historical confidence value associated with the plurality of observations.

The system 101 may further detect either one of the presence or absence of the environmental zone in the region for each sub-interval (hour of day) in the plurality of time intervals, wherein each sub-interval corresponds to the predefined length/epoch of time interval, such as 1 hour, 30 min, 15 min etc. The system 101 may be configured to generate the time schedule of the environmental zone in the region and indicates the presence or absence of the environmental zone in the region for each sub-interval in the plurality of time intervals for each day in a week using the calculations done as illustrated in table 400d. For example, the system 101 may obtain the plurality of observations at a location for a week. The week may be divided into days and day further into hours. The system 101 may further determine the plurality of positive observations and/or the plurality of negative observations for the region. By aggregating the plurality of positive observations and the plurality of negative observations as shown in table 400d, the system 101 may determine the confidence value for the environmental zone. For example, on Monday at 1 pm the confidence value may be 0.9 for the location and on Saturday the confidence value may be 0.2.

In some embodiments, the system 101 may compare the calculated confidence value to a threshold confidence value. The threshold confidence value may be customizable based on a variety of parameters, such as environmental pollution levels, type of region (for example school, hospital etc.), type of vehicle, weather, and the like. Based on the comparison of the confidence value with the threshold confidence value, the system 101 may generate the time schedule for the environmental zone. For example, if the threshold confidence value is set to be 0.4, then the system 101 may detect that on Monday at 1 pm, the environmental zone is present whereas on Saturday at 1 pm, the environmental zone is absent for the same location. In this way, the system 101 may generate the time schedule.

The system 101 may further provide routing and navigational assistance to the vehicles in a region. The system 101 may obtain route information for at least one vehicle. Based on the map data and route information, the system 101 may determine confidence values associated with different locations on the route in the region. Further, the system 101 may determine a coverage area for the environmental zone based on the determined confidence values for the different locations and provide the route navigational instructions to the vehicle.

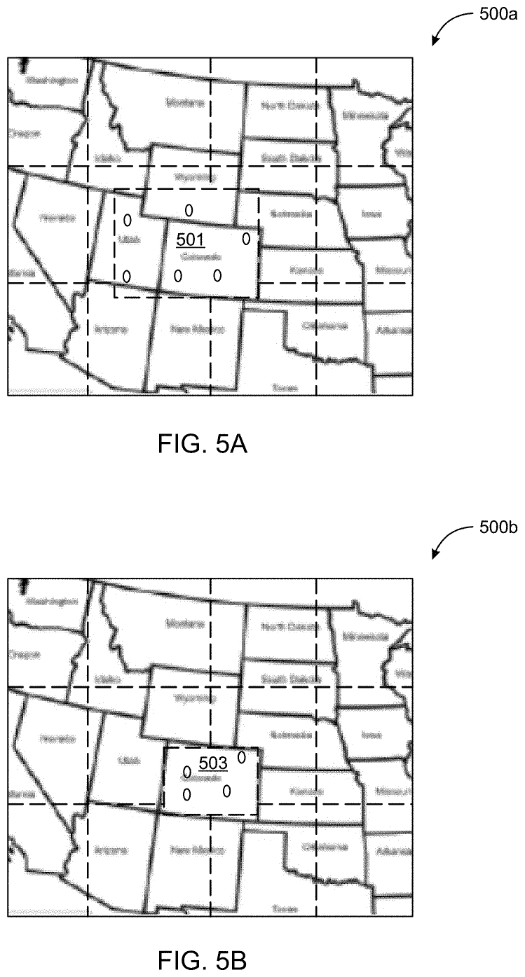

FIGS. 5A-5B illustrates an exemplary representation for detecting an environmental zone, in accordance with one or more example embodiments. FIGS. 5A-5B are explained in conjunction with FIGS. 3A-3B and FIGS. 4A-4D. In FIG. 5A, there is shown a region 500a with multiple tiles. In the region 500a, area bounded by dots 501 shows the coverage area associated with an environmental zone, with points in it showing plurality of observations. Similarly, in FIG. 5B, there is shown a region 500b (which is same as region 500a) with multiple tiles and 503 is the updated coverage area associated with the environmental zone in the region 500b, with points in it showing plurality of observations.

As explained previously, the system 101 may continuously monitor the change in confidence value associated with the environmental zones with coverage areas 501 or 503, and after determining the confidence value the system 101 may detect an updated coverage area associated with the environmental zone. For example, in FIG. 5A, the system 101 may detect the polygon shape of 501 based on the confidence value associated with the plurality of observations, whereas the polygon shape associated with the coverage area may change to 503 in FIG. 5B based on the change in confidence value associated with the plurality of observations.

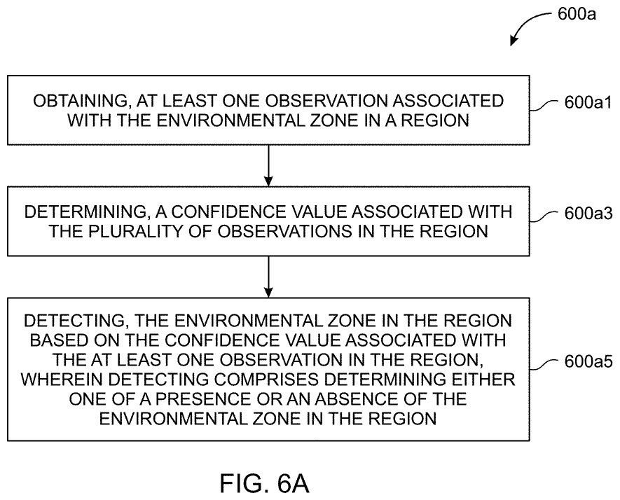

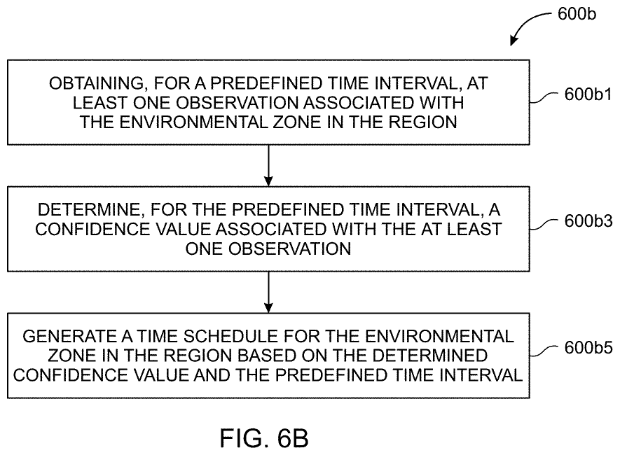

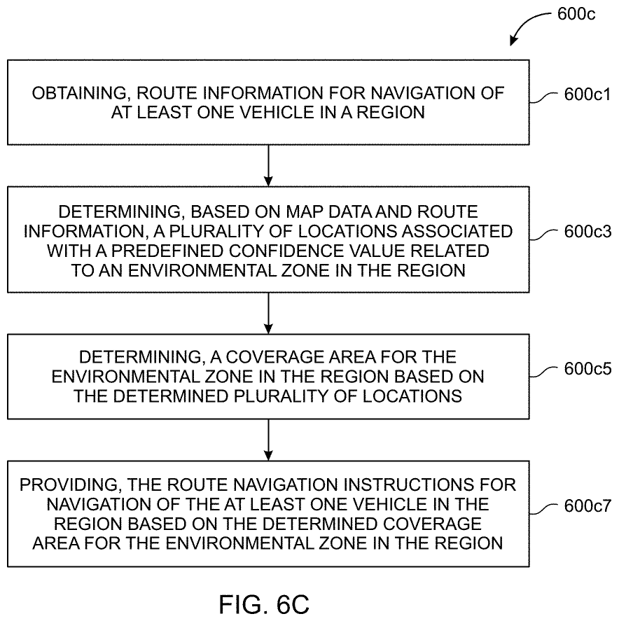

FIGS. 6A-6C illustrate flow diagrams of different method embodiments for detecting an environmental zone and generating a time schedule of an environmental zone in a region, in accordance with an example embodiment. It will be understood that each block of the flow diagram of methods 600a-600c may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The methods 600a-600c illustrated by the flowchart diagram of FIGS. 6A-6C is for detecting an environmental zone and generating a time schedule of an environmental zone in a region. Fewer, more, or different steps may be provided.

In accordance with method 600a, at step 600a1, the method 600a comprises obtaining at least one observation associated with the environmental zone in a region. The method further comprises obtaining the at least one observation associated with the environmental zone in the region based on at least one of a plurality of road signs, one or more pollution sensors, and one or more other sensors in a vehicle. In some embodiments, the system 101 obtains at least one observation for each time epoch. Further the system 101 obtains at least one observation from the first vehicle. Later, the system 101 may obtain the at least one observation for the second vehicle. In this manner a plurality of observations associated with the environmental zone may be obtained. The plurality of observations further comprise a plurality of positive observations and a plurality of negative observations, wherein each of the plurality of positive observations are associated with a first determination of presence of environmental zone in the region, and each of the plurality of negative observations are associated with a second determination of absence of environmental zone in the region.

At step 600a3, the method 600a comprises determining a confidence value associated with the at least one observation. For example, for an observation taken for the sub-interval 1 AM-2 AM, data from tables 400a and 400b may updated, and then a confidence value may be calculated using the formula in equation (1). The same determination may be done for the plurality of observations in the region. Further, the determined confidence value may be stored in the map database 103a. Further, the stored confidence value may be used by different applications like for route determination, re-routing of a vehicle, controlling vehicular emissions and the like. Also, the confidence value is updated in real time based on the updated observations. For example, while detecting the environmental zone and the coverage area, the system 101 may update the confidence value of a particular location when the system 101 determines that the confidence value of that location has changed.

In some embodiments, the method 600a further comprises determining the confidence value associated with the plurality of observations by aggregating the plurality of positive observations in the region and aggregating the plurality of negative observations in the region, and determining the confidence value based on the aggregated plurality of positive observations and the aggregated plurality of negative observations. This is shown in table 400d, where aggregated positive observation value and aggregated negative observation value is input to the formula in equation (1) in some embodiments, and the result of the calculation provides the confidence value for environmental zone for a region, such as area 501 shown in map 500a, for a particular time sub-interval, such as 3 AM-4 AM. The method 600a further comprises determining the confidence value by continuously monitoring a change in confidence value associated with each of the plurality of observations in the region in real time.

At step 600a5, the method 600a comprises detecting the environmental zone in the region based on the determined confidence value associated with the plurality of observations in the region, wherein detecting comprises determining either one of a presence or an absence of the environmental zone in the region. For example, the vehicle 301 travelling on road 303 may detect the region as environmental zone if the confidence value associated with the observation is greater than a threshold confidence value. As explained in FIG. 5A, the system 101 may detect that the region is an environmental zone on Monday from 1 AM to 2 AM as the confidence value is 85.71%. In this case, the threshold confidence value may be 40% for exemplary purpose. Similarly, the system 101 may detect that the region is not an environmental zone when the confidence value associated with the observation is less than the threshold confidence value. After detecting the environmental zone, the system 101 may also update the coverage of the environmental zone in the map database. For example, in FIG. 5A the coverage area is shown as polygon shape 501 and similarly in FIG. 5B the coverage area is shown as polygon shape 503 which is different from 501.

FIG. 6B illustrates another exemplary method 600b for generating a time schedule for an environmental zone in a region, according to an example embodiment.

The method 600b comprises, at step 600b1, obtaining, for a predefined time interval, at least one observation associated with the environmental zone in the region. In some embodiments, the mapping platform 103 includes one or more processors 103b, which are configured for obtaining the at least one observation from the vehicle 301, but after anonymization. The anonymization may either be done by the OEM cloud 109, or by the mapping platform 103 itself. Further, at least one observation may be associated with the region, such as the road 303, and for a predefined time interval, such as any of the sub-intervals included in tables 400a or 400b. Each such observation is used to populate corresponding table 400a or 400b, and thus, in this manner a plurality of observations is obtained from a plurality of vehicles.

The plurality of observations obtained in this manner include a plurality of positive observations associated with the environmental zone, such as in table 400a, in the region for the predefined time interval; and a plurality of negative observations associated with the environmental zone, such as in table 400b, in the region for the predefined time interval.

Further, the one or more processors 103, are further configured to aggregate, for the region and the predefined time interval, both the plurality of positive observations and the plurality of negative observations to determine a corresponding aggregated positive observation value and a corresponding aggregated negative observation value.

The method 600b further comprises, at step 600b3, determining, for the predefined time interval, a confidence value associated with the at least one observation. The confidence value is determined based on the aggregated positive observation value and the aggregated negative observation value. Further, based on the confidence value, the one or more processors 103b executing the method 600b are configured to detect, for the region and the predefined time interval, either one of a presence or an absence of the environmental zone and generate the time schedule of the environmental zone based on the detection.

Further, the method 600b comprises at step 600b5, the one or more processors in the system 101 are configured to generate a time schedule for the environmental zone in the region based on the determined confidence value and the predefined time interval. As explained in FIG. 4D, the confidence value on Monday from 1 AM to 2 AM is 85.71%, therefore the system 101 may determine the region on Monday from 1 AM to 2 AM as environmental zone. Similarly, the confidence value on Monday from 4 AM to 5 AM is 25%, therefore the system 101 may determine that the region is not an environmental zone on Monday from 4 AM to 5 AM. Therefore, based on this information, the system 101 may generate the time schedule for the environmental zone in the region.

In some embodiments, the generated time schedule may be used to predict the existence or non-existence of the environmental zone in the region.

In some embodiments, the generated time schedule is stored in the environmental zone related map layer of the map database 103a and is further used to update the map layer for missing data related to plurality of observations for a region where observations are not available. In such cases, positive and negative observations at nearby locations of the region where such observations are not available, can be used to replenish the missing information at the candidate location using a threshold constraint on distance (e.g. 2 km). From the environmental zone related map layer map layer, observations of nearby region may be obtained and given a weight. These are considered as implicit weighted observations. The weight of these implicit observations could be continuous, between 0 and 1, but depends on the distance of the candidate location to the real observations using a decay function. The implicit observations may be continuous values or may be Boolean values. After replenishing the map layer with implicit observations, the updated confidence value may be calculated, and further updated time schedule may be generated.

In some embodiments, for missing observations, the previously computed confidence for the previous sub-interval is used with a time decay. The time decay parameters may be configurable and can be tuned according to vehicle penetration or map attributes, such as functional class, URBAN/RURAL flag, and the like.

In some embodiments, the time schedule and coverage area of the environmental zone determined using any of the methods 600a or 600b discussed above may be used to provide navigation assistance to the vehicle 301.

FIG. 6C illustrates another exemplary method 600c for providing route navigation instructions to one or more vehicles in a region, in accordance with an exemplary embodiment.

The method 600c comprises, at step 600c1, obtaining route information for navigation of at least one vehicle in a region. For example, the vehicle 301 may request for a route to a destination from a start location of the vehicle 301. The system 101 may obtain routing information stored in map database 103a and provide the route for navigation as part of the requested route to the vehicle 301. For example, the route may include road 303 as part of the requested route for navigation.

The method 600c further comprises, at step 600c3, determining, based on map data and route information, a plurality of locations associated with a confidence value related to an environmental zone in the region. The plurality of locations comprises at least one location falling on the requested route.

In some embodiments, the requested route may include locations that fall within a coverage area of the environmental zone. When the map database 301 determines the plurality of locations that make the requested route, then, using the time of day and each location of the plurality of locations, a confidence value for each location of the plurality of locations is calculated. For example, using the calculations outlined in FIGS. 4A-4D, and methods 600a-600b, confidence value at each location for the time of day is calculated. Further, a threshold confidence value may be identified. For example, the threshold may be set at 60% or 0.6. Then, high confidence locations with confidence value more than 60% may be aggregated to form a polygon describing the coverage area of the environmental zone. In some embodiments, the clustering may be done using any known clustering algorithm, such as DB-SCAN, Affinity propagation, Gaussian Mixture Model, K-Means, Balanced Iterative Reduced Clustering using Hierarchies (BIRCH) and the like, to identify high confidence locations within the region. Further, using these high confidence locations, a polygon formation algorithm (e.g. convex hull) may be used to determine the extent of the polygon. The extent of the polygon then defines the coverage area of the environmental zone in the region, for the requested route of navigation.

At step 600c5, the method 600c includes, determining the coverage area for the environmental zone in the region based on the plurality of locations, and in the form of polygons as described previously. The polygons may then be used at step 600c7, for providing the route navigation instructions for the navigation of at least one vehicle, such as the vehicle 301. The vehicle 301 may be subscribed to the services of the mapping platform 103 for receiving navigational alerts. As part of these alerts, the polygons defining extent of environmental zone on the requested route of navigation of the vehicle 301 may be sent to the vehicle 301 as it approaches or departs from the environmental zone.

In some embodiments, the polygons defining extent of environmental zone on the requested route of navigation of the vehicle 301 may be used during route planning to avoid the area depicted in the polygon if active or to allow the area to be included in the routing if it is estimated to not be active during the expected travel times.

In some embodiments, these navigational alerts may be cancelled using a time-to-live (e.g. 45 minutes) or when the confidence drops below a threshold. The time-to-live parameter can be determined using a sample of ground truth data.

In some embodiments, the polygon extent may be redetermined. For example, when the confidence value associated with at least one location for is changed and is determined to fall below the predetermined threshold value, the location may be cancelled as falling within the coverage area of the environmental zone. Further the clustering algorithm may be executed again, and the polygon formation algorithm is also re-executed to determine the new extent of the polygon. The new extent of the polygon defines the updated coverage area of the environmental zone.

Thus, the methods 600a-600c are configured to provide a continuously updated value of confidence, by monitoring in real time, each of the locations falling within the region designated for environmental zone detection. Further, the continuous monitoring also enables provision of accurate, real time, up to date and reliable environmental zone information the users.

In some embodiments, the operations described in each of the methods 600a-600c may enable providing the route navigation instructions for navigation of the at least one vehicle in the region based on the determined coverage area for the environmental zone in the region.

In some embodiments, the route navigation instructions may be related to controlling the operation of the at least one vehicle. For example, the vehicle 301 may be alerted that they are approaching a green zone area, so they must switch on an emission control system. Alternately, if the vehicle 301 is an autonomous vehicle, the emission control system may be automatically switched on to control the emission of pollutants from the vehicle 301.

In some embodiments, the vehicle 301 may be provided alternate routes for navigation as part of the navigation instructions.

In some embodiments, the vehicle 301 may give a choice of an optimized route of travel, a green zone based route of travel or a long route of travel as part of the navigation instruction.

In some embodiments, the system 101 may provide routing instruction in one or more of a message alert, an audio message or a notification, a visual display, a visual indicator and the like. For example, the routing instruction may comprise displaying on a user interface of the user equipment 105, an alternate route that is not an environmental zone. In another embodiment, the routing instruction may instruct the vehicle 301 to change the emission operation so that the vehicle emits less fuel emission (that is compatible for environmental zone) and still able to cross the environmental zone.

The methods 600a-600c may be implemented using corresponding circuitry. For example, the method 600a may be implemented by an apparatus or system comprising a processor, a memory, and a communication interface of the kind discussed in conjunction with FIG. 2.

In some example embodiments, a computer programmable product may be provided. The computer programmable product may comprise at least one non-transitory computer-readable storage medium having stored thereon computer-executable program code instructions that when executed by a computer, cause the computer to execute the various methods discussed in FIGS. 6A-6C.

In an example embodiment, an apparatus for performing any of the methods 600a-600c of FIGS. 6A-6C above may comprise a processor (e.g. the processor 201) configured to perform some or each of the operations of the methods 600a-600c described previously. The processor may, for example, be configured to perform the operations (600a1-600a5, 600b1-600b5, and 600c1-600c7) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (600a1-600a5, 600b1-600b5, and 600c1-600c7) may comprise, for example, the processor 201 which may be implemented in the system 101 and/or a device or circuit for executing instructions or executing an algorithm for processing information as described above.

In this way, example embodiments of the invention result in detecting the coverage of environmental zone and generating a time schedule of an environmental zone. The generation of the time schedule may help in assisting user to provide alternate route. The invention may help user to alert while driving based on the detection of environmental zone in a timely and targeted way in advance. The invention also updates the coverage of the environmental zone in a map database.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

I/We claim:

1. A method for detecting an environmental zone, the method comprising:
obtaining at least one observation associated with the environmental zone in a region;
determining a confidence value associated with the at least one observation in the region; and
detecting the environmental zone in the region based on the confidence value associated with the at least one observation in the region, wherein detecting comprises determining either one of a presence or an absence of the environmental zone in the region.

2. The method of claim 1, wherein detecting the environmental zone further comprises detecting a coverage area associated with the environmental zone in the region.

3. The method of claim 2, further comprising generating a time schedule for the environmental zone based on the determined coverage area of the environmental zone in the region.

4. The method of claim 3, further comprising predicting either one of the presence or absence of the environmental zone based on the generated time schedule and the coverage area of the environmental zone.

5. The method of claim 1, wherein obtaining the at least one observation associated with the environmental zone in the region further comprises obtaining the at least one observation based on at least one of road sign data, one or more pollution sensors, and one or more other sensors in a vehicle.

6. The method of claim 1, wherein the at least one observation further comprises at least one of a positive observation and a negative observation, wherein the positive observation is associated with a first determination of presence of environmental zone in the region and the negative observation is associated with a second determination of absence of environmental zone in the region.

7. The method of claim 6, wherein each of the at least one positive observation and the at least one negative observation is associated with a time interval associated with each day in a week.

8. The method of claim 6, wherein determining the confidence value associated with the at least one observation comprises:
determining a plurality of observations in the region for the time interval associated with the at least one observation, wherein the plurality of observations include a plurality of positive observations and a plurality of negative observations;
aggregating the plurality of positive observations to determine an aggregated positive observation value;
aggregating the plurality of negative observations to determine an aggregated negative observation value; and
determining the confidence value based on the aggregated positive observation value and the aggregated negative observation value.

9. The method of claim 1, wherein determining the confidence value further comprises monitoring, in real time, a change in confidence value associated with the at least one observation in the region.

10. The method of claim 1, further comprising determining confidence value of at least one missing observation for the region based on a historical confidence value associated with the at least one observation.

11. The method of claim 1, further comprising generating navigational alerts associated with the detection of the environmental zone in the region.

12. The method of claim 1, further comprising generating alternate routes for navigation based on the detection of the environmental zone.

13. The method of claim 1, further comprising updating a coverage of the environmental zone in a map database, wherein the coverage is indicated by a polygon shape in the map database.

14. The method of claim 1, wherein the region comprises at least one of a location point, a map tile area, a road segment, and a lane.

15. A system for generating a time schedule of an environmental zone in a region, the system comprising:
a memory configured to store computer-executable instructions; and
one or more processors configured to execute the instructions to:
obtain, for a predefined time interval, at least one observation associated with the environmental zone in the region;
determine, for the predefined time interval, a confidence value associated with the at least one observation; and
generate a time schedule for the environmental zone in the region based on the determined confidence value and the predefined time interval.

16. The system of claim 15, wherein the one or more processors are further configured to:
determine for the predefined interval, a plurality of observations comprising a plurality of positive observations associated with the environmental zone in the region for the predefined time interval and a plurality of negative observations associated with the environmental zone in the region for the predefined time interval;
aggregate, for the region and the predefined time interval, both the plurality of positive observations and the plurality of negative observations to determine a corresponding aggregated positive observation value and a corresponding aggregated negative observation value;
determine, for the region and the predefined time interval, the confidence value based on the aggregated positive observation value and the aggregated negative observation value;
detect, for the region and the predefined time interval, either one of a presence or an absence of the environmental zone based on the confidence value; and
generate the time schedule of the environmental zone based on the detection.

17. The system of claim 16, wherein to generate the time schedule of the environmental zone in the region, the one or more processors are further configured to:
identify a plurality of time intervals for each day in a week;
detect, for each sub-interval in the plurality of time intervals, either one of the presence or absence of the environmental zone in the region, wherein each sub-interval corresponds to the predefined time interval; and
generate the time schedule of the environmental zone in the region based on detection, wherein the generated time schedule comprises data indicating either one of the presence or absence of the environmental zone in the region for each sub-interval in the plurality of time intervals for each day in the week.

18. The system of claim 17, wherein the one or more processors are further configured to generate navigational alerts for at least one vehicle based on the generated time schedule, wherein the navigation alerts comprise one or more route navigation instructions for the at least one vehicle based on the presence or absence of the environmental zone in the region at a time of navigation of the at least one vehicle through the region.

19. The system of claim 15, wherein the one or more processors are further configured to:
identify, in real-time, a change in the confidence value associated with the at least one observation; and
generate an updated time schedule for the environmental zone in the region based on the determined change in the confidence value and the predefined time interval.

20. A computer programmable product comprising a non-transitory computer readable medium having stored thereon computer executable instructions which when executed by one or more processors, cause the one or more processors to carry out operations for providing navigation instructions, the operations comprising:
obtaining route information for navigation of at least one vehicle in a region;
determining, based on map data and the route information, at least one location associated with a confidence value related to an environmental zone in the region;
determining a coverage area for the environmental zone in the region based on the determined at least one location; and
providing the navigation instructions for operation of the at least one vehicle in the region based on the determined coverage area for the environmental zone in the region.
